(19) United States
(12) Patent Application Publication
(10) Pub. No.: US 2017/0005316 A1
(43) Pub. Date: Jan. 5, 2017

(54) CURRENT CARRIER FOR VEHICLE ENERGY-STORAGE SYSTEMS

(71) Applicant: Faraday&Future Inc., Gardena, CA (US)

(72) Inventors: W. Porter Harris, Los Angeles, CA (US); Nicholas John Sampson, Rancho Palos Verdes, CA (US)

(21) Appl. No.: 15/045,517

(22) Filed: Feb. 17, 2016

Related U.S. Application Data
(63) Continuation-in-part of application No. 14/938,746, filed on Nov. 11, 2015.
Application No. 14/938,746 is a continuation-in-part of application No. 14/841,617, filed on Aug. 31, 2015.
(60) Provisional application No. 62/186,977, filed on Jun. 30, 2015.

(51) Int. Cl. H01M 2/20; H01M 2/30; H01M 2/10

(52) U.S. Cl. CPC H01M 2/206; H01M 2/1077; H01M 2/305; H01M 2220/20

(57) ABSTRACT

A current carrier may include a circuit board that may be connected to a plurality of battery cells. Each of the battery cells may include a first end, an anode terminal on the first end, and a cathode terminal on the first end of the battery cell. Each battery cell may be positioned so that the first end of each of the plurality of battery cells is oriented in the same direction. The circuit board may include a first layer. The first layer may include a first group of positive contacts that may be electrically connected to cathode terminals of a first group of battery cells among the plurality of battery cells. The circuit board may also include a second layer. The second layer may include a first group of negative contacts that may be electrically connected to anode terminals of the first group of battery cells.

### CROSS-REFERENCE TO RELATED APPLICATIONS

This application is a continuation-in-part of U.S. patent application Ser. No. 14/938,746, filed Aug. 31, 2015, which claims the benefit of U.S. Provisional Application No. 62/186,977, filed on Jun. 30, 2015. The subject matter of the aforementioned applications is incorporated herein by reference.

### FIELD

The present application relates generally to energy-storage systems, and more specifically to energy-storage systems for vehicles.

### BACKGROUND

Electric-drive vehicles may reduce the impact of fossil-fuel engines on the environment and increase the sustainability of automotive modes of transportation. Energy-storage systems are essential for electric-drive vehicles, such as hybrid electric vehicles, plug-in hybrid electric vehicles, and all-electric vehicles. Size, efficiency, and safety are important considerations for these energy-storage systems. Spatially efficient storage, improved thermal management, and balance among battery cells, promote these goals.

The current carrier and battery module disclosed herein may be directed to addressing one or more of the possible drawbacks discussed above and/or other problems of the prior art.

### SUMMARY

In one aspect, the present disclosure is directed to a current carrier. The current carrier may include a circuit board that may be connected to a plurality of battery cells. Each of the battery cells may include a first end, an anode terminal on the first end, and a cathode terminal on the first end of the battery cell. Each battery cell may be positioned so that the first end of each of the plurality of battery cells is oriented in the same direction. The circuit board may include a first layer. The first layer may include a first group of positive contacts that may be electrically connected to cathode terminals of a first group of battery cells among the plurality of battery cells. The circuit board may also include a second layer. The second layer may include a first group of negative contacts that may be electrically connected to anode terminals of the first group of battery cells.

In another aspect, the present disclosure is directed to a battery module. The battery module may include a plurality of battery cells. Each of the battery cells may include a first end, an anode terminal on the first end, and a cathode terminal on the first end of the battery cell. Each battery cell may be positioned so that the first end of each of the plurality of battery cells is oriented in the same direction. The battery module may also include a current carrier. The current carrier may include a circuit board. The circuit board may include a first layer. The first layer may include a first group of positive contacts that may be electrically connected to cathode terminals of a first group of battery cells among the plurality of battery cells. The circuit board may also include a second layer. The second layer may include a first group of negative contacts that may be electrically connected to anode terminals of the first group of battery cells.

In yet another aspect, the present disclosure is directed to a vehicle. The vehicle may include a battery module. The battery module may include a plurality of battery cells. Each of the battery cells may include a first end, an anode terminal on the first end, and a cathode terminal on the first end of the battery cell. Each battery cell may be positioned so that the first end of each of the plurality of battery cells is oriented in the same direction. The battery module may also include a current carrier. The current carrier may include a circuit board. The circuit board may include a first layer. The first layer may include a first group of positive contacts that may be electrically connected to cathode terminals of a first group of battery cells among the plurality of battery cells. The circuit board may also include a second layer. The second layer may include a first group of negative contacts that may be electrically connected to anode terminals of the first group of battery cells.

### BRIEF DESCRIPTION OF THE DRAWINGS

FIG. 1 is a diagrammatic illustration of an exemplary electric vehicle.

FIG. 2A is a diagrammatic illustration of an exemplary battery pack.

FIG. 2B is a diagrammatic illustration of an exemplary battery pack disposed in an exemplary enclosure.

FIG. 3 is a diagrammatic illustration of exemplary coolant flows in an exemplary battery back.

FIGS. 4A and 4B are diagrammatic illustrations of an exemplary coupling arrangement between two exemplary battery modules.

FIG. 5 is a diagrammatic illustration of an exemplary battery module.

FIG. 6 is a diagrammatic illustration of an exemplary battery module with the current carrier and battery cells removed from one of the half modules of the battery module.

FIG. 7 is a diagrammatic illustration of an exemplary battery module with the current carrier removed from one of the half modules of the battery module.

FIG. 8 is a diagrammatic illustration of an exemplary half module.

FIG. 9 is a diagrammatic illustration of an exemplary battery cell.

FIG. 10 is a diagrammatic illustration of an exemplary current carrier.

FIG. 11 is a diagrammatic illustration of an exemplary current carrier.

FIG. 12 is a front view of an exemplary current carrier.

FIG. 13 is a side view of an exemplary current carrier.

FIG. 14 is a detailed diagrammatic illustration of an exemplary current carrier.

FIG. 15A is an exploded view of an exemplary current carrier.

FIG. 15B is another exploded view of an exemplary current carrier.

FIG. 15C is a detailed diagrammatic illustration of the circuit design of an exemplary current carrier.

### DETAILED DESCRIPTION

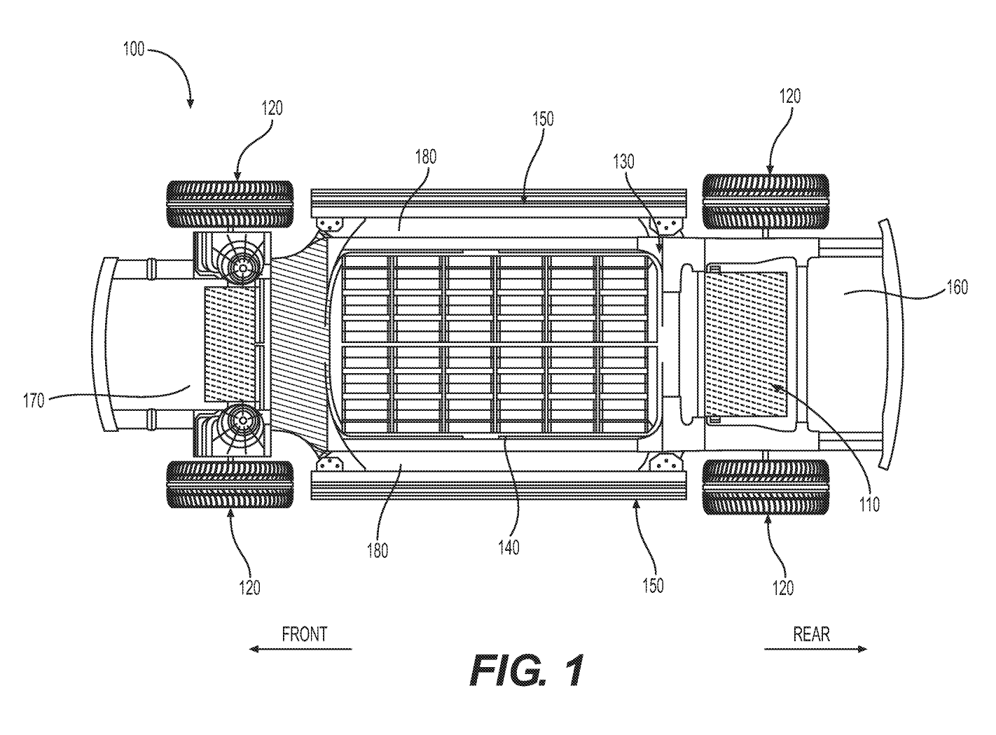

FIGS. 1-15 illustrate exemplary components and systems for current carriers and battery modules. Such current carriers and battery modules may be implemented in a vehicle of any type. For example, the vehicle may be a car, truck, semi-truck, motorcycle, plane, train, moped, scooter, or other type of transportation. Furthermore, the vehicle may use many types of powertrain. For example, the vehicle may be an electric vehicle, a fuel cell vehicle, or a hybrid vehicle. Though described with reference to vehicle components, the exemplary current carriers and battery modules are not limited to use in vehicles. For example, the current carriers and battery modules may be used to power domestic or commercial appliances.

FIG. 1 is a diagrammatic illustration of an exemplary electric vehicle 100. Electric vehicle 100 may propelled by one or more electric motors 110. Electric motor 110 may be coupled to one or more wheels 120 through a drivetrain (not shown in FIG. 1). Electric vehicle 100 may include a frame 130 (also known as an underbody or chassis). Frame 130 may be a supporting structure of electric vehicle 100 to which other components may be attached or mounted, such as, for example, a battery pack 140. Electric vehicle 100 may further include structural rails 150, rear crumple zone 160, front crumple zone 170, and lateral crumple zone 180.

Battery pack 140 may be disposed such that it may be at least partially enclosed by frame 130. Battery pack 140 may be positioned at a predefined distance from structural rails 150. In some embodiments, battery pack 140 may be positioned such that frame 130, structural rails 150, rear crumple zone 160, front crumple zone 170, and lateral crumple zone 180 protect battery pack 140 from forces or impacts exerted from outside of electric vehicle 100, for example, in a collision. In some embodiments, battery pack 140 may be disposed in frame 130 to help improve directional stability (e.g., yaw acceleration). For example, battery pack 140 may be disposed in frame 130 such that a center of gravity of electric vehicle 100 may be in front of the center of the wheelbase (e.g., it may be bounded by a plurality of wheels 120).

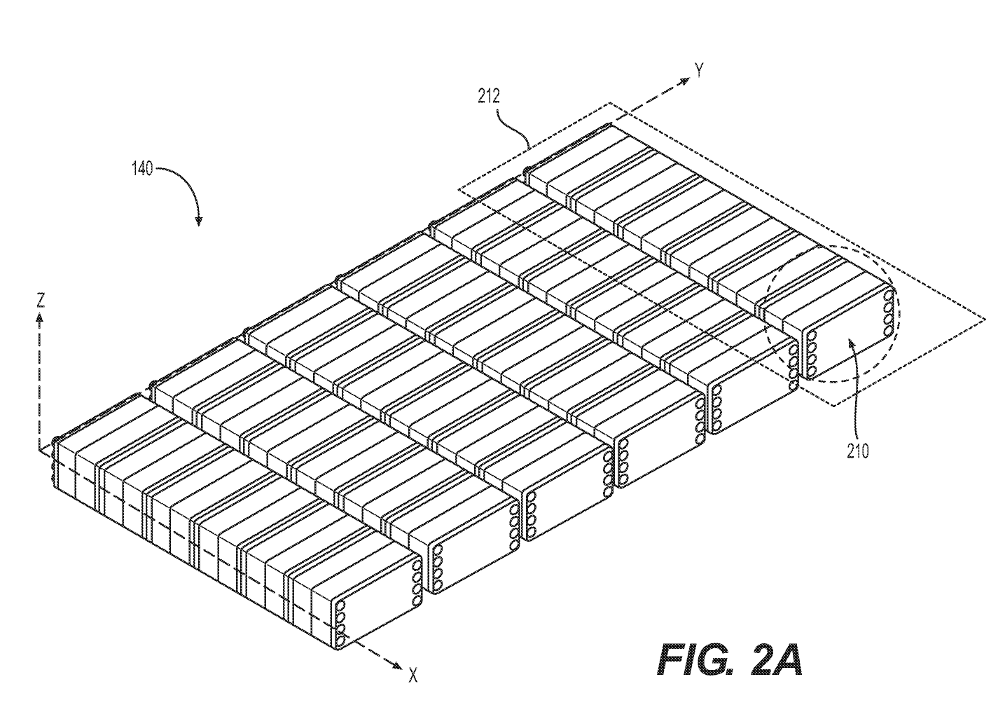

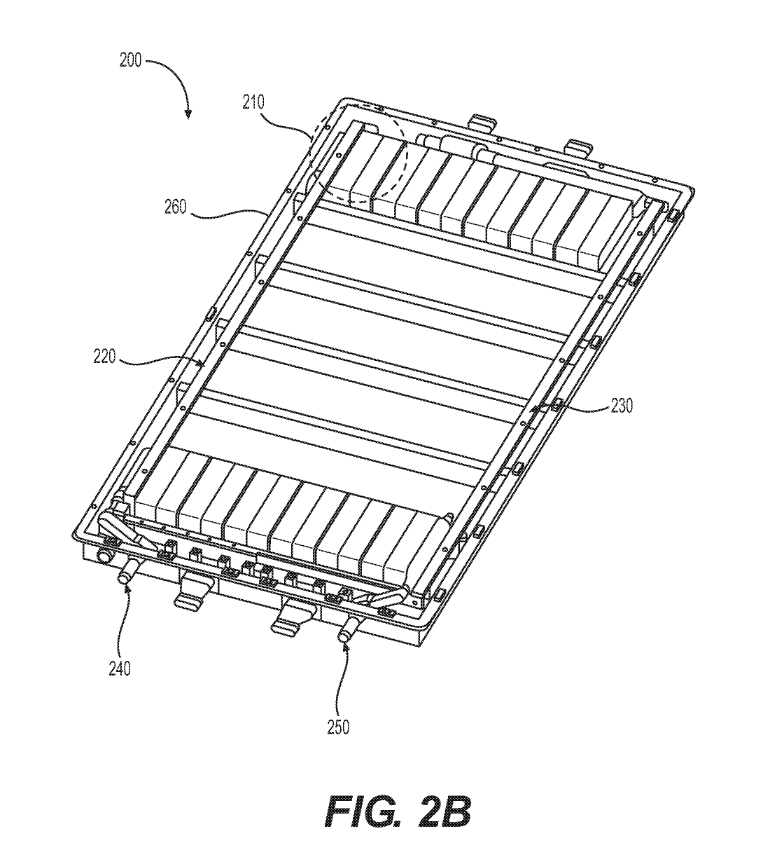

FIG. 2A is a diagrammatic illustration of exemplary battery pack 140. Imaginary x-, y-, and z-axes are depicted on battery pack 140. Battery pack 140 may be of any size and dimensions. For example, battery pack 140 may be approximately 1000 mm wide (along x-axis), 1798 mm long (along y-axis), and 152 mm high (along z-axis).

Battery pack 140 may include a plurality of battery modules 210. In one example, battery pack 140 may include thirty-six battery modules 210. At least some of battery modules 210 may be electrically connected in a series forming a string 212, and two or more strings 212 may be electrically connected in parallel. In this exemplary configuration, if one of strings 212 fails, others of strings 212 may not be affected.

FIG. 2B depicts exemplary battery pack 140 in an exemplary enclosure 200. Enclosure 200 may include a tray 260. Enclosure 200 may further include a cover (not illustrated).

Tray 260 may include a positive bus bar 220 and a negative bus bar 230. Negative bus bar 230 and positive bus bar 220 may be disposed along opposite edges of tray 260, or may be disposed to have a predefined separation between negative bus bar 230 and positive bus bar 220.

Positive bus bar 220 may be electrically coupled to a positive portion of a power connector of each battery module 210. Negative bus bar 230 may be electrically coupled to a negative portion of a power connector of each battery module 210. Positive bus bar 220 may be electrically coupled to a positive terminal 240 of enclosure 200. Negative bus bar 230 may be electrically coupled to a negative terminal 250 of enclosure 200. When used in electric vehicle 100, bus bars 220 and 230 may be disposed within structural rails 150.

In electric vehicle 100, battery pack 140 may supply electricity to power one or more electric motors 110, for example, through an inverter. The inverter may change direct current (DC) from battery pack 140 to alternating current (AC), as may be required for electric motors 110, according to some embodiments.

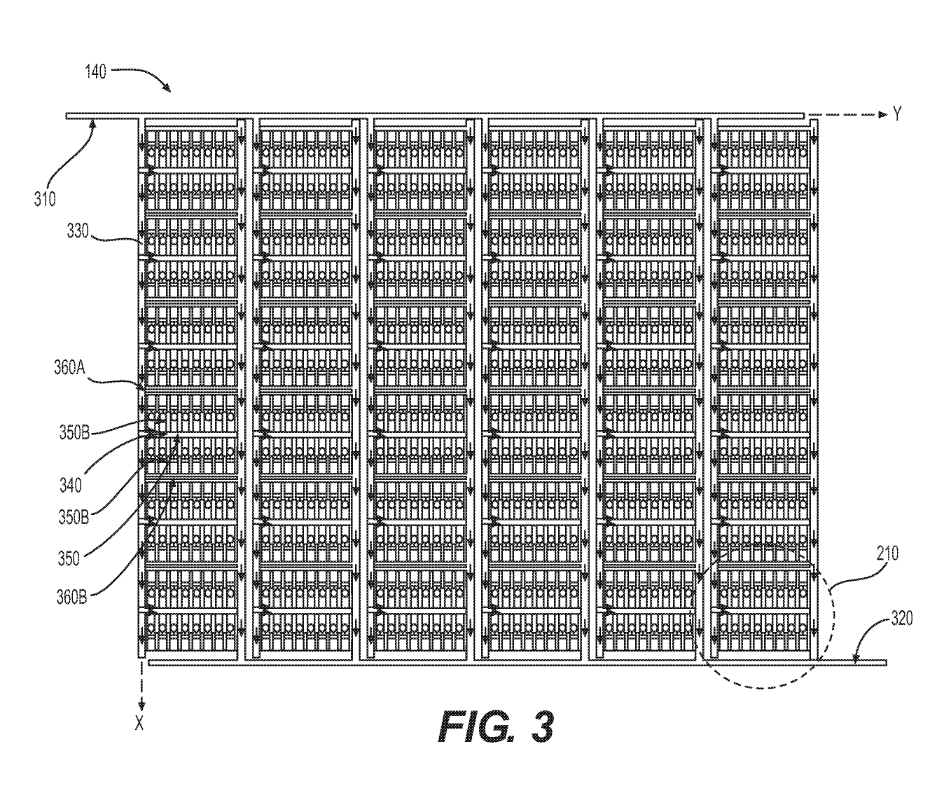

FIG. 3 illustrates exemplary coolant flows and the exemplary operation of an exemplary coolant system and an exemplary coolant sub-system that may be used in conjunction with battery pack 140. As depicted in FIG. 3, an exemplary coolant system may include an ingress 310 and an egress 320. For example, coolant may be pumped into battery pack 140 at ingress 310 and pumped out of battery pack 140 at egress 320. For example, coolant may be routed in parallel to each of battery modules 210 in battery pack 140. The resulting pressure gradient within battery pack 140 may provide sufficient circulation of coolant to minimize a temperature gradient within battery pack 140 (e.g., a temperature gradient within one of battery modules 210, a temperature gradient between battery modules 210, and/or a temperature gradient between two or more of strings 212 shown in FIG. 2A).

Within battery pack 140, the coolant system may circulate the coolant, for example, to battery modules 210 (e.g., reference numeral 330 indicates the circulation). Coolant may include at least one of the following: synthetic oil, for example, poly-alpha-olefin (or poly-a-olefin, also abbreviated as PAO) oil, ethylene glycol and water, liquid dielectric cooling based on phase change, and the like.

One or more additional pumps (not shown) may be used to maintain a roughly constant pressure between multiple battery modules 210 connected in series (e.g., in string 212 in FIG. 2A) and between such strings.

The coolant sub-system may circulate coolant within battery modules 210 (e.g., the circulation indicated by reference numeral 340). In some embodiments, the coolant may enter each battery module 210 through an interface 350. The coolant may flow through battery module 210. Interface 350 may be oriented to channel coolant into battery module 210 along the y-axis. Coolant may then be driven by pressure within the coolant system to flow out of battery module 210 through one or more channels 350b oriented along the x-axis. Coolant may then be collected at the two (opposite) side surfaces 360A and 360B of the module. Side surfaces 360A and 360B may be normal to the x-axis. In some embodiments, the coolant and sub-coolant systems may be used to maintain a substantially uniform and/or constant temperature within battery pack 140.

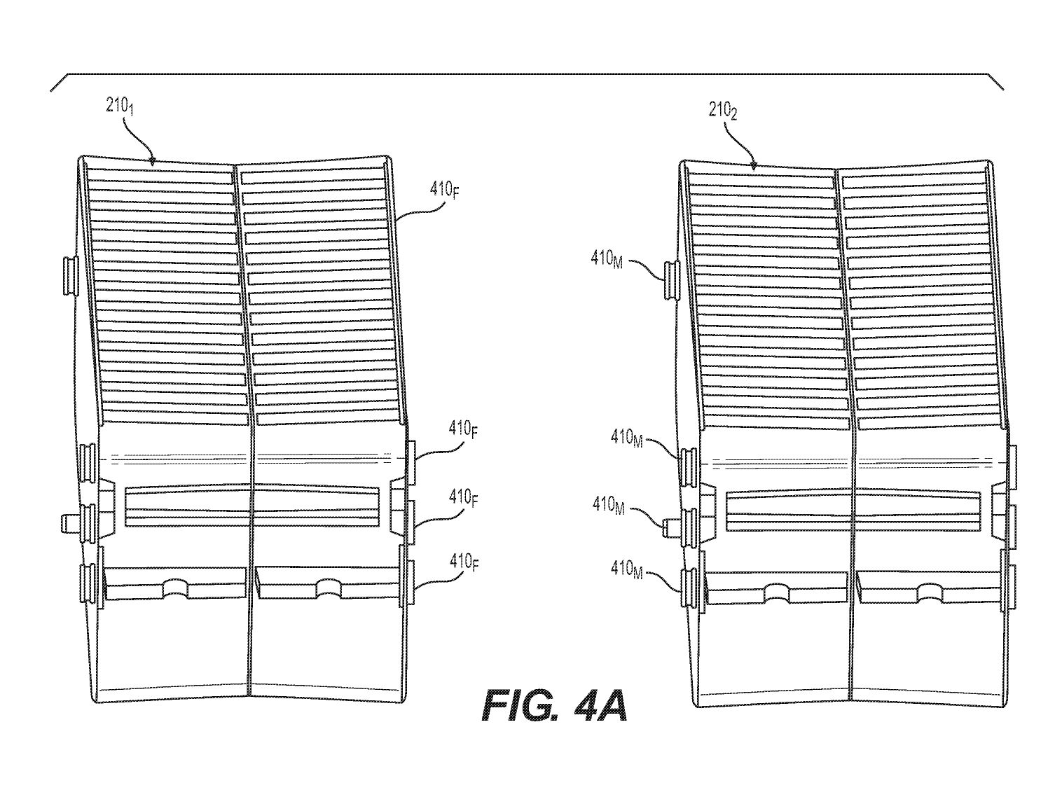

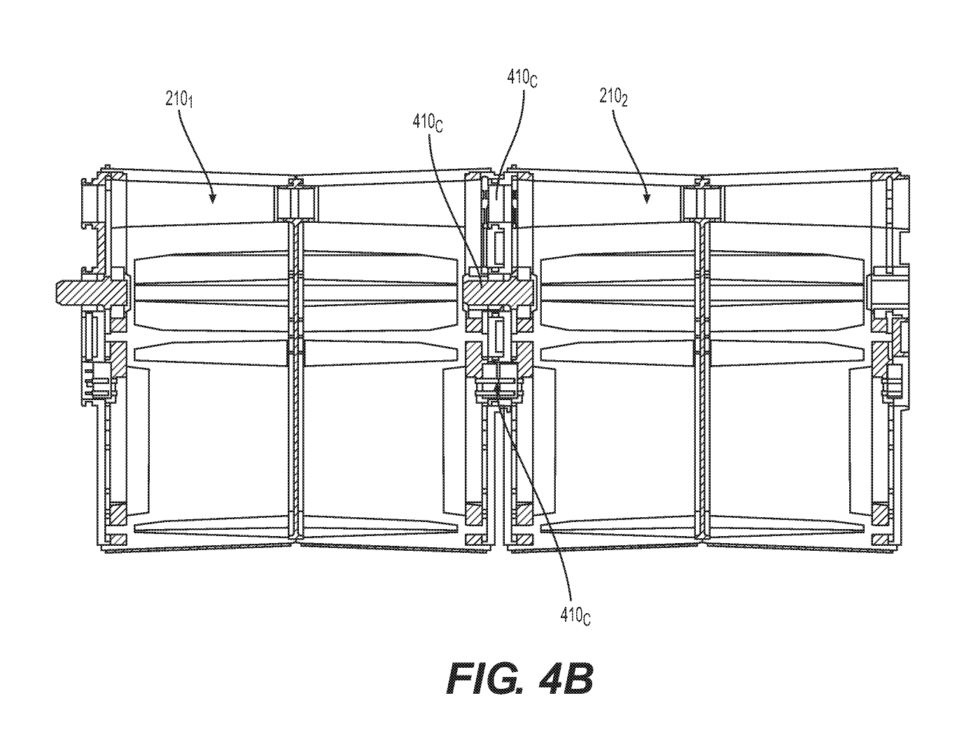

As discussed, exemplary battery pack 140 may include multiple battery modules 210. FIGS. 4A and 4B illustrate exemplary arrangements and couplings between two battery modules 210: 210₁ and 210₂. FIG. 4A depicts exemplary battery modules 210₁ and 210₂ separated but aligned for coupling. For example, battery modules 210₁ and 210₂ may be positioned as shown in FIG. 4A and then moved together until coupled as shown in the example in FIG. 4B. Generally, female connectors 410_{F} on one of battery modules 210₁ and 210₂ may receive and engage male connectors 410_{M} on the other of battery modules 210₂ and 210₁, respectively. One or more female-male connector pairings may be included on each of battery modules 210₁ and 210₂.

As shown in the example in FIG. 4A, a left side of battery modules 210₁ and 210₂ may have male connectors 410_{M}, and a right side of battery modules 210₁ and 210₂ may have female connectors 410_{F}. Alternatively, a mix of male connectors 410_{M} and female connectors 410_{F} may be used. Each female connector 410_{F} may include an (elastomer) o-ring or other seal. Male connectors 410_{M} and female connectors 410_{F} may act only as connection points or may also be power connectors, coolant ports, etc.

FIG. 4B depicts a cross-sectional view of exemplary battery modules 210₁ and 210₂ coupled together. For example, male connectors 410_{M} and female connectors 410_{F} combine to form coupled connectors 410_{c}. As discussed, male connectors 410_{M} and female connectors 410_{F} may be power connectors or coolant ports of battery modules 210. For example, one of male connectors 410_{M} may be a coolant output port of battery module 210₂, and one of female connectors 410_{F} may be a female coolant output port of battery module 210₁. Thus, the male and female ports may be coupled, and the internal cooling channels of the battery modules may be connected, for example, forming the cooling system schematically illustrated in FIG. 3. Similarly, multiple battery modules 210 may be electrically connected via a male connector 410_{M} and a female connector 410_{F} when coupled together.

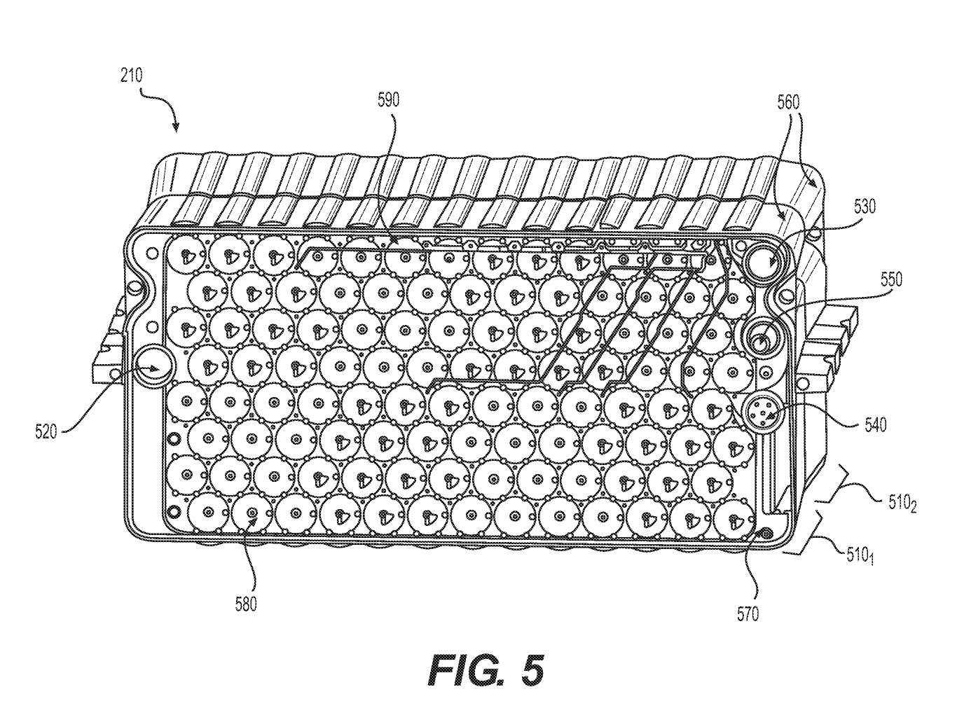

FIG. 5 is a diagrammatic illustration of an exemplary battery module 210. Battery module 210 may include two half modules 510₁ and 510₂, coolant input port 520, coolant output port 530, communications and low power connector 540, and/or main power connector 550.

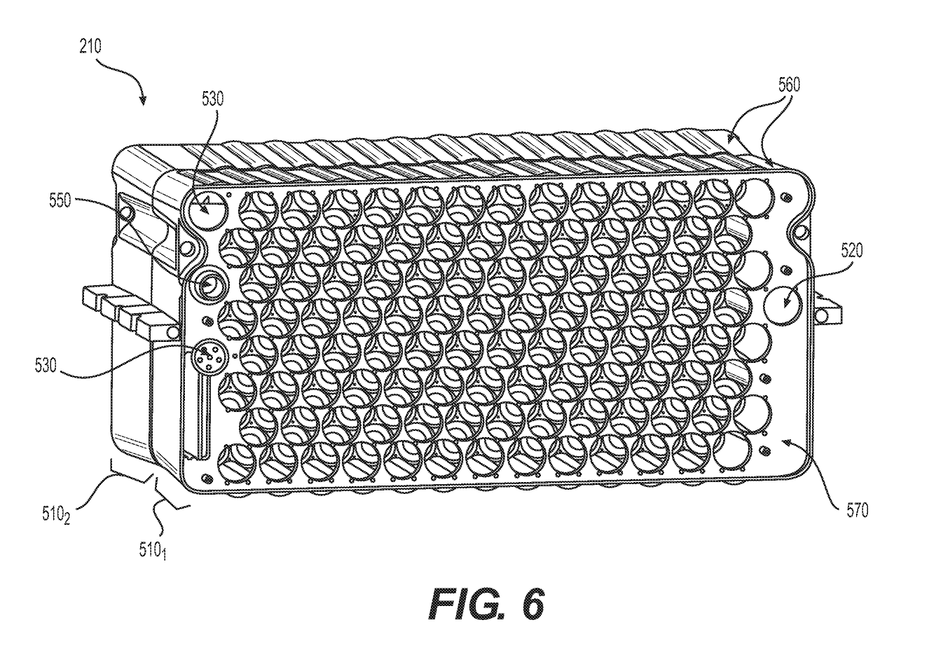

Each of half modules 510₁ and 510₂ may also include an enclosure 560 for housing battery cells therein. Enclosure 560 may further include a plate 570 (discussed in greater detail with respect to FIG. 6).

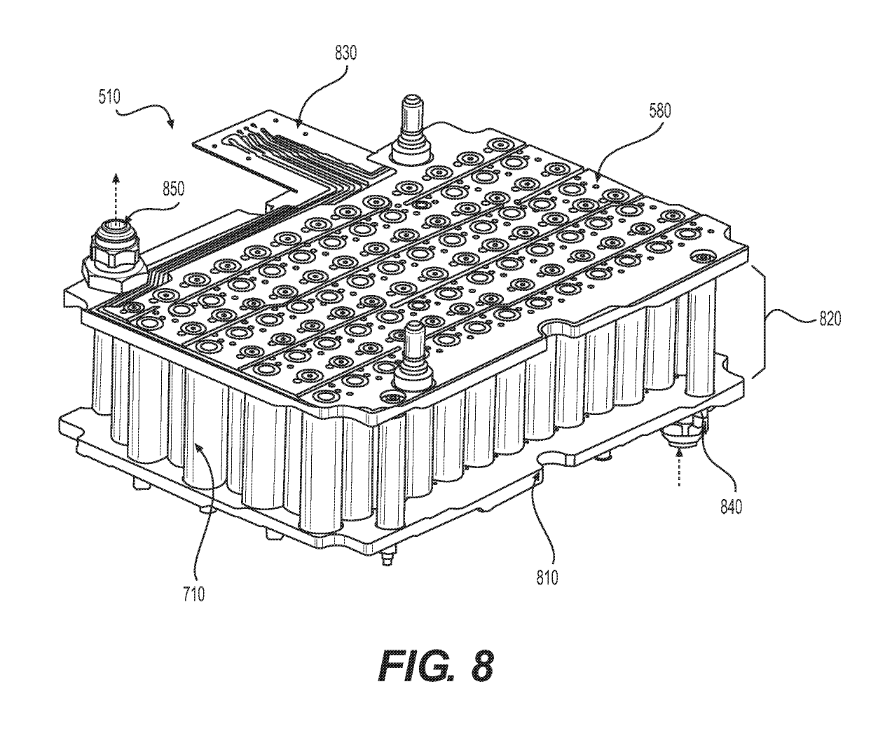

Half modules 510₁ and 510₂ of battery module 210 may further include a current carrier 580 (discussed in more detail with reference to FIGS. 8 and 9-15), and may include one or more staking features 590, for example, a plastic stake, to hold current carrier 580 in battery module 210. Half modules 510₁ and 510₂ may be the same or may be different (e.g., half modules 510₁ and 510₂ may be mirror images of each other in some embodiments).

Coolant may be provided to battery module 210 at main coolant input port 520, circulated within battery module 210, and received at main coolant output port 530.

Communications and low power connector 540 may provide low power, for example, to electronics for data acquisition and/or control, and sensors. In some embodiments, communications and low power connector 540 may be at least partially electrically coupled to current carrier 580, for example, through electronics for data acquisition and/or control.

Each of coolant input port 520, coolant output port 530, communications and low power connector 540, and main power connector 550 may serve as male connectors 410_{M} and female connectors 410_{F}.

FIG. 6 is a diagrammatic illustration of battery module 210, with the battery cells and current carrier 580 removed from one of the half modules for illustrative purposes. As described, battery module 210 may include two half modules 510₁ and 510₂, main power connector 550, main coolant output port 530, main coolant input port 520, and communications and low power connector 540. Further, each of the half modules 510₁ and 510₂ may include enclosure 560.

Enclosure 560 may be made using one or more plastics having sufficiently low thermal conductivities. Respective enclosures 560 of each of the half modules may be coupled with one another other to form the housing for battery module 210. Enclosure 560 may additionally include a cover (not illustrated). Each enclosure 560 may further include plate 570 (e.g., a bracket). Plate 570 may include structures for securing the battery cells within enclosure 560 and maintaining the distance between battery cells.

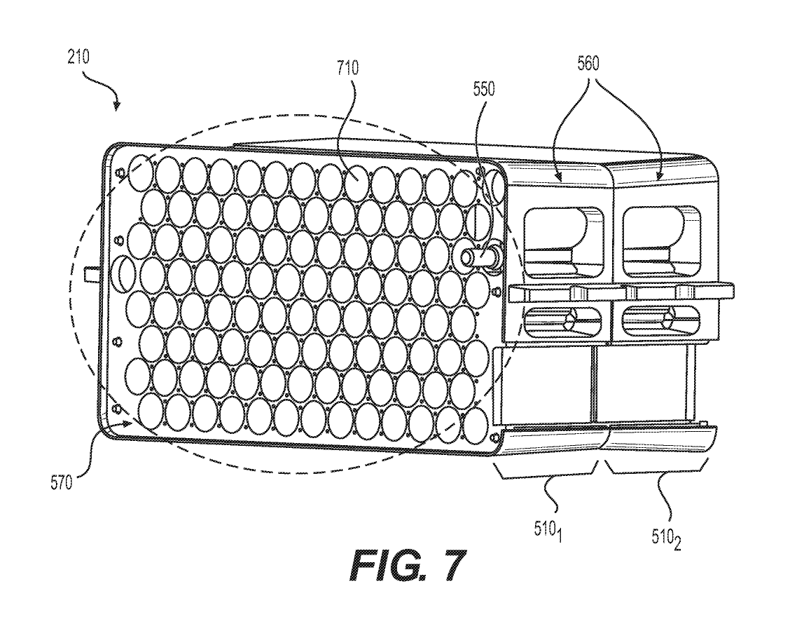

FIG. 7 is a diagrammatic illustration of an exemplary battery module 210, with current carrier 580 removed from one of the half modules for illustrative purposes. Each half module may include at least one battery cell 710. Main power connector 550 may provide power from battery cells 710 to outside of battery module 210.

FIG. 8 is a diagrammatic illustration of half module 510 without enclosure 560. Half module 510 may include a coolant intake 840 and a coolant egress 850, which may allow for use of the coolant sub-system discussed with reference to FIG. 3. Half module 510 may further include an electrical interface 830, which may be electrically connected to current carrier 580. Electrical interface 830 may be coupled to communications and low power connector 540. Half module 510 may also include a plurality of battery cells 710. Battery cells 710 may have a cylindrical body, and may be disposed between current carrier 580 and blast plate 810 in space 820, such that an exterior side of each of battery cells 710 may not be in contact with the exterior sides of other (e.g., adjacent) battery cells 710.

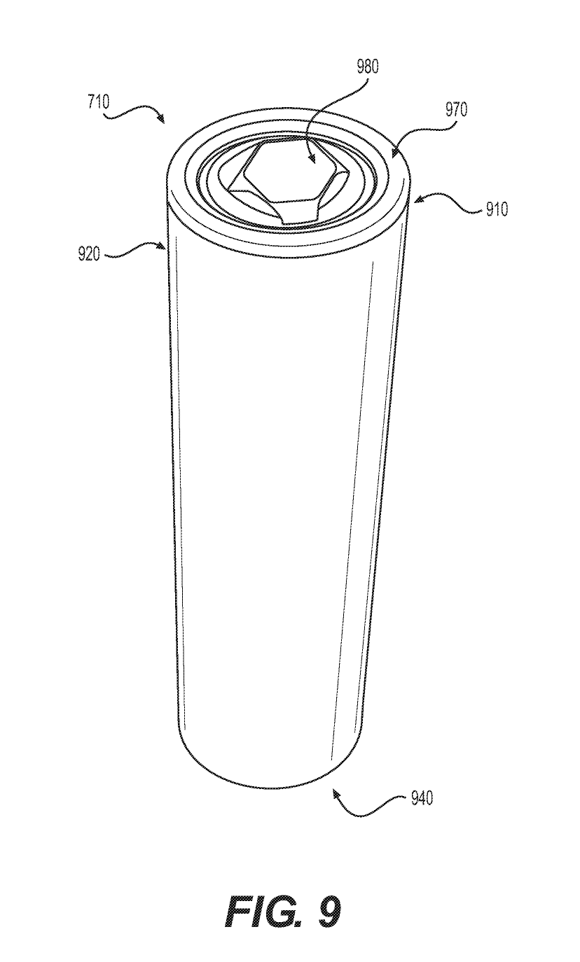

FIG. 9 depicts an exemplary battery cell 710. In some embodiments, battery cell 710 may be a lithium ion (li-ion) battery. For example, battery cell 710 may be an 18650 type li-ion battery that may have a cylindrical shape with an approximate diameter of 18.6 mm and approximate length of 65.2 mm. Other rechargeable battery form factors and chemistries may additionally or alternatively be used. In various embodiments, battery cell 710 may include a first end 910, a can 920 (e.g., the cylindrical body), and a second end 940. Both an anode terminal 970 and a cathode terminal 980 may be disposed on first end 910. Anode terminal 970 may be a negative terminal of battery cell 710, and cathode terminal 980 may be a positive terminal of battery cell 710. Anode terminal 970 and cathode terminal 980 may be electrically isolated from each other by an insulator or dielectric.

Battery cell 710 may also include scoring on second end 940 to promote rupturing so as to effect venting in the event of over pressure. In various embodiments, all battery cells 710 may be oriented to allow venting into the blast plate 810 for both half modules.

Within half module 510, battery cells 710 may be disposed such that the cylindrical body of the battery cell may be parallel to the imaginary x-axis (“x-axis cell orientation”). According to some embodiments, x-axis cell orientation may offer additional safety and efficiency benefits. For example, in the event of a defect in half module 510 or battery module 210, the battery cells may be vented along the x-axis. Further, according to some embodiments, x-axis cell orientation may also be advantageous for efficient electrical and fluidic routing to each of battery module 210 in battery pack 140.

In addition, x-axis cell orientation may also be advantageous, according to some embodiments, for routing coolant (cooling fluid) in parallel to each of battery modules 210 in battery pack 140, for example, as may be seen in FIG. 8. Using the coolant systems described with reference to FIG. 3, coolant may enter half module 510 through coolant intake 840 and may exit through coolant egress 850. Coolant intake 840 and coolant egress 850 may each be male or female fluid fittings.

Channels 350B may be formed within the spaces between the cylindrical bodies of adjacent battery cells 710. Channels 350B may be metal tubes, but may also be spaces between the cylindrical bodies of battery cells 710, which may allow for higher battery cell density within battery module 210, in some embodiments by 15%. Channels 350B may or may not occupy the entire space between adjacent battery cells 710. Air pockets, which may reduce the weight of half module 510, may also be formed in the space between adjacent battery cells 710.

Such an exemplary parallel cooling system may be used to maintain the temperature of battery cells 710 within battery module 210 (and across battery back 140) at an approximately uniform level. According to some embodiments, the direct current internal resistance (DCIR) of each battery cell may vary with temperature; therefore, keeping each battery cell in battery pack 140 at a substantially uniform and predefined temperature range may allow each battery cell to have substantially the same DCIR. Voltage across each battery cell may be reduced as a function of its respective DCIR, and therefore each battery cell 710 in battery pack 140 may experience substantially the same loss in voltage. In this exemplary way, according to some embodiments, each battery cell 710 in battery pack 140 may be maintained at approximately the same capacity, and imbalances between battery cells 710 in battery pack 140 may be minimized.

According to some embodiments, each of half modules 510₁ and 510₂ may include the same number of battery cells 710. For example, each half module may include one hundred-four battery cells 710. Battery cells 710 may be electrically connected via current carrier 580. For example, thirteen of battery cells 710 may form a group and may be electrically connected in parallel, with a total of eight of such groups of thirteen battery cells 710 electrically connected in series. This exemplary configuration may be referred to as “8S 13P” (8 series, 13 parallel). Other combinations and permutations of battery cells 710 electrically coupled in series and/or parallel may be used. Exemplary grouping of the battery cells is discussed in greater detail in connection with a current carrier that provides electrical connection among the battery cells.

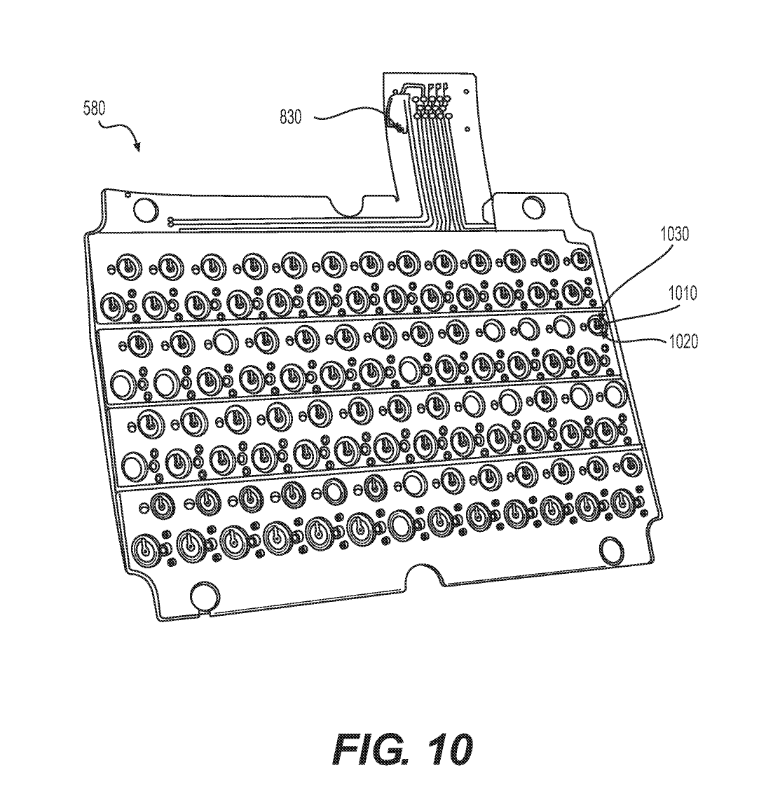

FIG. 10 is a diagrammatic illustration of an exemplary current carrier 580. Current carrier 580 may be generally planar, and may be of any size and dimensions depending on the size and dimensions of half module 510. Current carrier 580 may be in electrical connection with battery cells 710 and may conduct current between the battery cells through, e.g., a positive contact 1010, a negative contact 1020, and a fuse 1030. For example, positive contact 1010 may be in electrical contact with cathode terminal 980 and negative contact 1020 may be in electrical contact with anode terminal 970. Current carrier 580 may be electrically coupled to electrical interface 830, which may transport signals from current carrier 580, for example from a signal plane of current carrier 580. Electrical interface 830 may include an electrical connector (not shown). Current carrier 580 may also provide electrical connectivity to outside of battery module 210, for example, through main power connector 550.

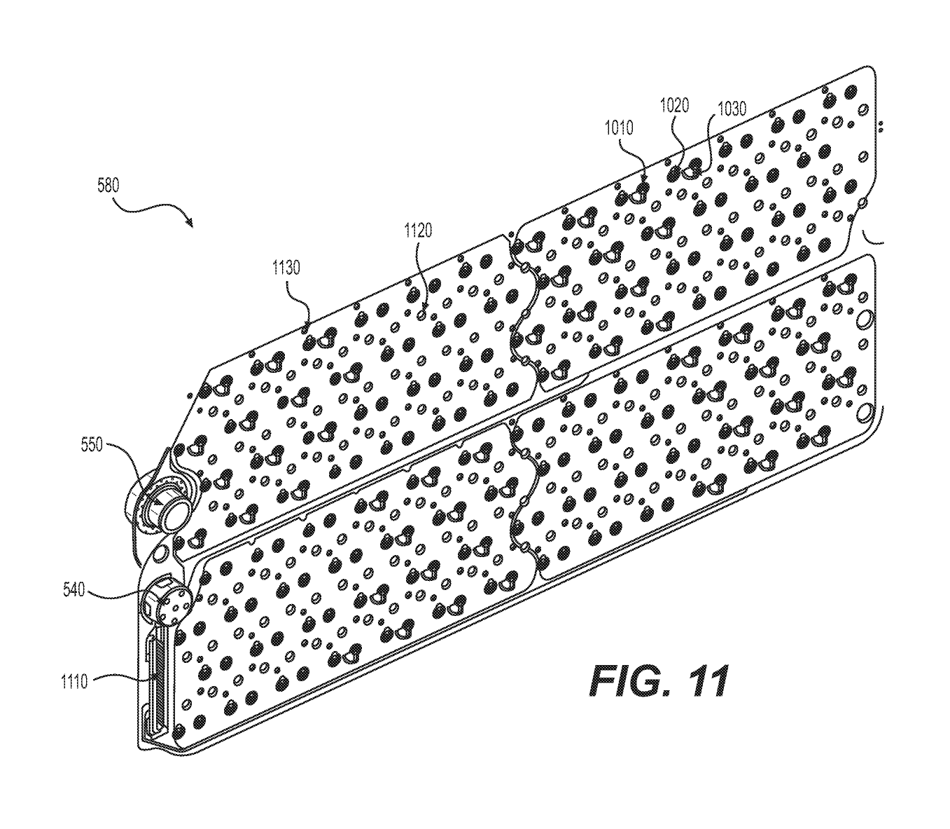

FIG. 11 is a second diagrammatic illustration of an exemplary current carrier 580. As shown in FIG. 11, main power connector 550 and low power connector 540 may be coupled to current carrier 580. According to some embodiments, current carrier 580 may also include a telemetry board connector 1110, medium holes 1120, and small holes 1130.

Telemetry board connector 1110 may communicatively couple a telemetry board (not shown) with current carrier 580 and communications and low power connector 540. For example, the telemetry board may include electronics for data acquisition and/or control, and sensors, such as for battery module telemetry.

Medium holes 1120 and small holes 1130 may be used to affix current carrier 580 to plate 570. For example, current carrier 580 may be hot staked to a plate 570 through small holes 1130 or medium holes 1120, or small holes 1130 or medium holes 1120 may be coupled to staking features 590. Alternatively or in addition, coolant may be circulated through medium holes 1120 and/or small holes 1130.

Current carrier 580 may include a printed circuit board and a flexible printed circuit. For example, the printed circuit board may variously include at least one of copper, FR-2 (phenolic cotton paper), FR-3 (cotton paper and epoxy), FR-4 (woven glass and epoxy), FR-5 (woven glass and epoxy), FR-6 (matte glass and polyester), G-10 (woven glass and epoxy), CEM-1 (cotton paper and epoxy), CEM-2 (cotton paper and epoxy), CEM-3 (non-woven glass and epoxy), CEM-4 (woven glass and epoxy), and CEM-5 (woven glass and polyester). By way of further non-limiting example, the flexible printed circuit may include at least one of copper foil and a flexible polymer film, such as polyester (PET), polyimide (PI), polyethylene naphthalate (PEN), polyetherimide (PEI), along with various fluoropolymers (FEP), and copolymers.

As shown in FIG. 11, current carrier 580 may also be composed of multiple sections in order to implement flexible configuration of electrical connection of battery cells 710.

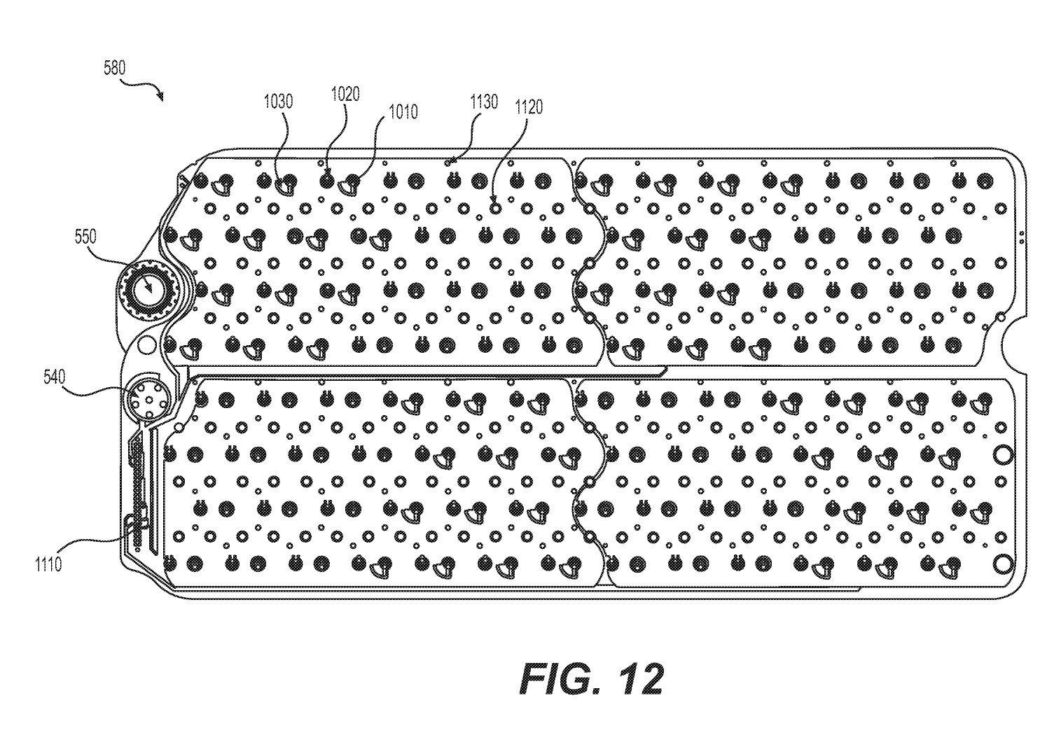

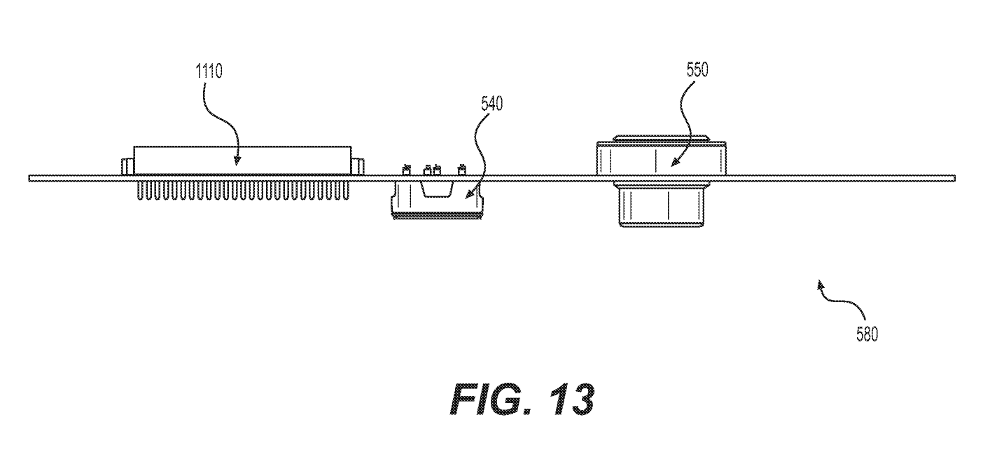

FIGS. 12 and 13 are alternative views of an exemplary current carrier 580. Current carrier 580 may include multiple layers, which may be sandwiched between dielectric isolation layers (e.g., made of polyimide).

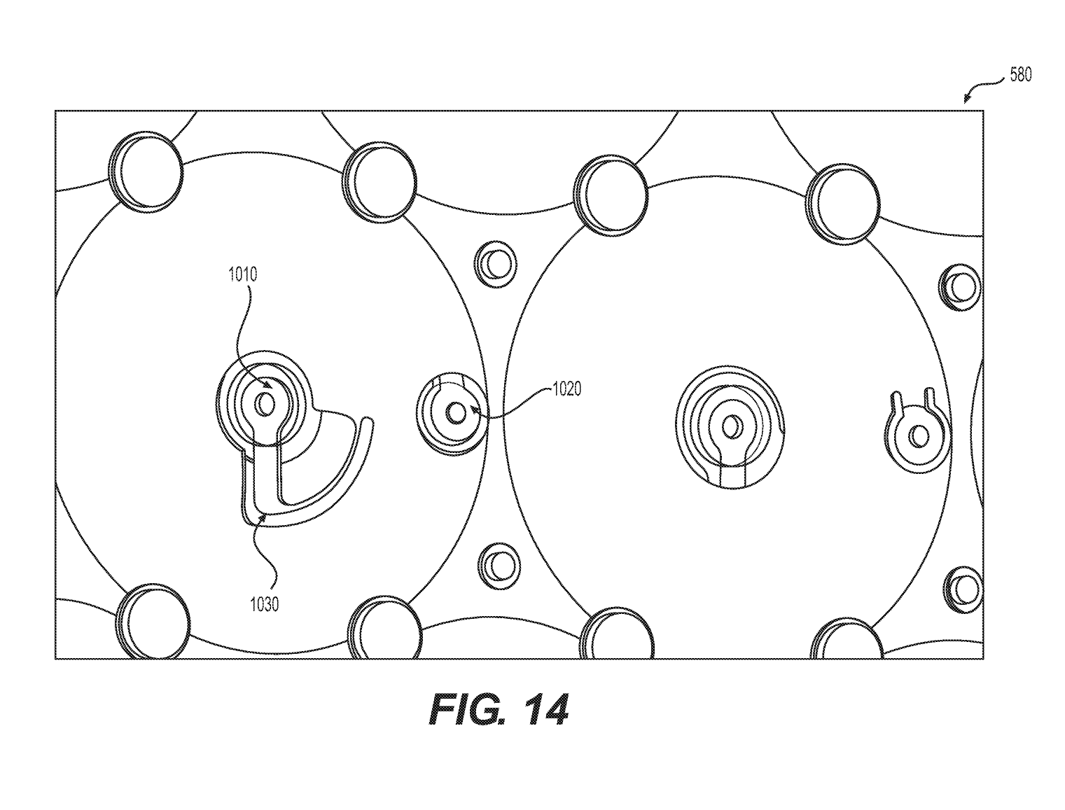

According to some embodiments, current carrier 580 may provide electrical connectivity between and among battery cells 710. As noted, current carrier 580 may be electrically connected to a plurality of battery cells 710, and may connect battery cells 710 in series or in parallel. FIG. 14 is a detailed diagrammatic illustration of an exemplary current carrier 580. FIG. 14 depicts exemplary positive contact 1010, negative contact 1020, and fuse 1030. Current carrier 580 may include a plurality of each of positive contacts 1010, negative contacts 1020, and fuses 1030.

Positive contact 1010 and negative contact 1020 may be separate. The position and shape of positive contact 1010 and negative contact 1020 may vary based on the shape of battery cell 710. In some embodiments, positive contact 1010 may be welded (e.g., laser welded) to a cathode terminal 980 of battery cell 710, and negative contact 1020 may be welded (e.g., laser welded) to an anode terminal 970 of battery cell 710. In some embodiments, the welded connection may have on the order of 5 milli-Ohms of resistance or less. In contrast, electrically coupling the elements using ultrasonic bonding of aluminum bond wires may have on the order of 10 milli-Ohms resistance. Welding may also have lower resistance for greater power efficiency and may take less time to perform than ultrasonic wire bonding.

Current carrier 580 may be configured such that a positive contact 1010 and a negative contact 1020 may be connected to the respective cathode and anode terminals of respective battery cells 710, for example, when the first end 910 of each battery cells 710 is oriented in the same direction. Therefore, two battery cells 710 may be connected in series with each other when negative contact 1020 connected to the anode of the first battery cell is electrically connected with the positive contact 1020 connected to the cathode of the second battery. Likewise, two battery cells 710 may be connected in parallel with each other when negative contacts 1020 connected with the cells are electrically connected with each other.

Accordingly, by designing the electrical connectivity of positive contacts 1010 and negative contacts 1020 on current carrier 580, battery cells 710 may be connected in series or in parallel. For example, a group of battery cells 710 may be connected in parallel via a plurality of electrically connected positive contacts 1010 of current carrier 580, and the respective plurality of electrically connected negative contacts 1020 of current carrier 580. According to some embodiments, a first group and a second group of batteries 710 may be connected in series if negative contacts 1020 of the first group are electrically connected with positive contacts 1010 of the second group. According to some embodiments, the number of battery cells in the first group and the number of battery cells in the second group may be the same or different.

Current carrier 580 may also include fuse 1030, which may be formed from part of a metal layer (e.g., copper, aluminum, etc.) of current carrier 580. In some embodiments, fuse 1030 may be formed (e.g., laser etched) in a metal layer to dimensions corresponding to a type of low-resistance resistor, and may act as a sacrificial device to provide overcurrent protection. For example, in the event of thermal runaway of one of battery cell 710 (e.g., due to an internal short circuit), the fuse may “blow,” and may break the electrical connection to the battery cell 710 and electrically isolate the battery cell 710 from current carrier 580.

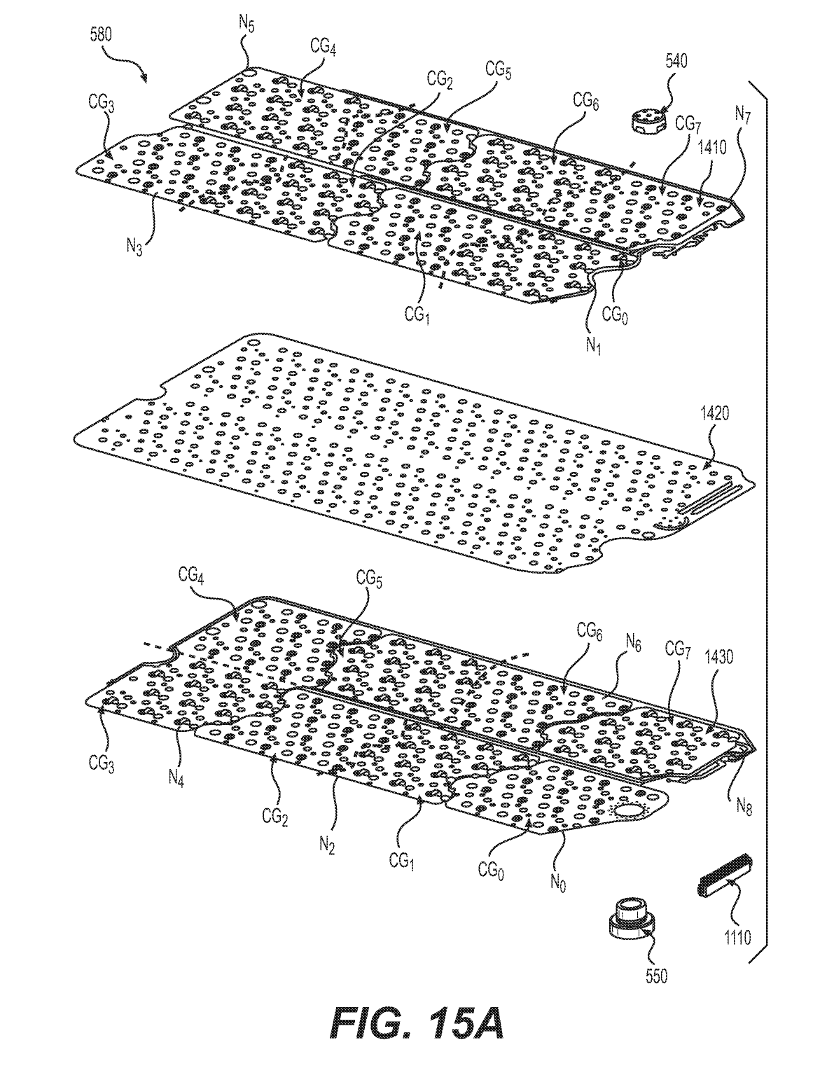

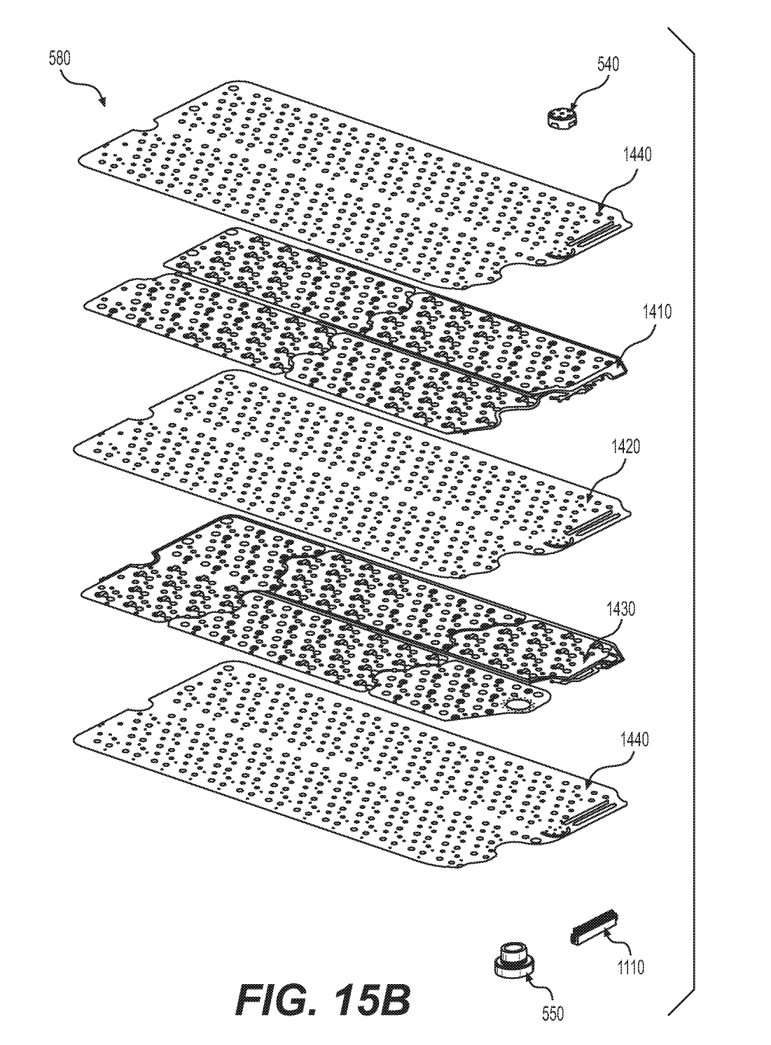

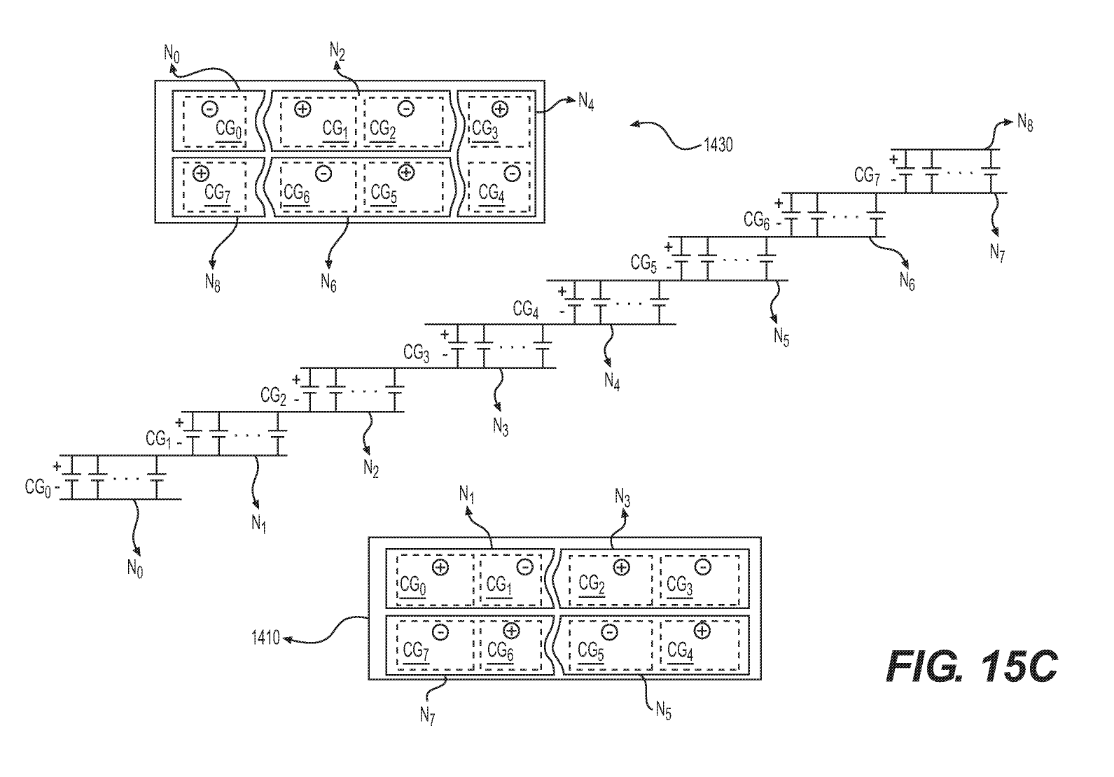

FIG. 15A illustrates an exemplary current carrier 580. Current carrier 580 may include main power connector 550, low power connector 540, and/or telemetry board connector 1110. Current carrier 580 may include a first layer 1410, a base layer 1420, which may provide dielectric isolation, and a second layer 1430. As depicted in FIG. 15B, one or more isolation layers 1440 may also be included in current carrier 580. Current carrier 580 may further include a signal plane, which in some embodiments may include signal traces and may be used to provide battery module telemetry (e.g., battery cell voltage, current, state of charge, and/or temperature from optional sensors on current carrier 580) to outside of battery module 210. Alternatively, the signal plane may be integrated into one or more layers of current carrier 580 or may be omitted.

First layer 1410 and second layer 1430 may be disposed on a respective first side and second side of base layer 1420.

As shown in FIGS. 15A and 15C, first layer 1410 may include multiple sections. Similarly, second layer 1430 may include multiple sections. Each section may include a group of contacts electrically connected with the anodes/cathodes of the respective battery cells 710 in a cell group. Each section may have the same number of contacts or may have a different number of contacts. The contacts within each section may be positive contacts 1010 or negative contacts 1020.

First layer 1410 and second layer 1430 may include sections of any shape or dimensions, depending on the desired positioning of battery cells 710, the desired shape and size of battery module 210, and the desired electrical connection between and among battery cells 710. First layer 1410 and second layer 1430 may be composed of metal or other conductive materials known in the art. Both first layer 1410 and second layer 1430 may also have more or fewer sections than depicted in FIGS. 15A and 15C. Second layer 1430 may have the same number of sections as first layer 1410 or may have a different number of sections.

When used in half module 510, current carrier 580 may electrically connect the plurality of battery cells 710 in half module 510. The plurality of battery cells 710 in half module 510 may be divided into groups and may be oriented such that the first end 910 of each battery cell 710 is oriented in the same direction. For example, according to some embodiments, the plurality of battery cells 710 may be divided into eight cell groups CG₀ to CG₇. According to some embodiments, the number of battery cells 710 in each cell group may be the same. It is also contemplated that the number of battery cells 710 in a cell group may be different than the number of battery cells 710 in another cell group. The anode terminal 970 of each of battery cell 710 within a first cell group may be electrically connected to a negative contact 1020 on first layer 1410 of current carrier 580. The cathode terminal 980 of each battery cell 710 within the first cell group may be electrically connected to a positive contact 1010 on second layer 1430. The contacts that are electrically connected together form an equipotential surface (referred to as a “node”). Battery cells 710 within each cell group are thus connected between two nodes.

For example, a first cell group CG₀ may be electrically coupled between node N₀ on second layer 1430 and node N₁ on first layer 1410. Thus, battery cells 710 in the cell group CG₀ are electrically connected in parallel.

A second cell group CG₁ may be electrically coupled between node N₁ on first layer 1410 and node N₂ on second layer 1430. Thus, battery cells 710 in the second cell group CG₁ are also electrically connected in parallel. Battery cells 710 of the first cell group CG₀ and battery cells 710 of the second cell group CG₁ are electrically connected in series.

Similarly, a third cell group CG₂ may be electrically coupled between node N₂ on second layer 1430 and node N₃ on first layer 1410. Thus, battery cells 710 within the third cell group CG₂ may be electrically connected in parallel. Battery cells 710 of the third cell group CG₂ and the second cell group CG₁ are electrically connected in series.

The remaining cell groups CG₃ to CG₇ may be similarly connected. As a result, battery cells 710 within each of the eight cell groups may be electrically connected in parallel and the respective cell groups may be electrically connected in series. This exemplary circuitry is depicted in FIG. 15C.

The exemplary circuit configuration described above may increase the number of battery cells within a compact package. For example, all battery cells 710 within half module 510 may be oriented in the same direction, and still connected via this exemplary three-dimensional circuit design. With the disclosed current carrier 580, the series and parallel connections may be realized by alternating positive and negative contact groups between the multiple nodes within layers 1410 and 1430 of current carrier 580, rather than physically reorienting battery cells 710. This exemplary configuration may also result in simplified manufacturing.

Though described herein with respect to a vehicle, as would be readily appreciated by one of ordinary skill in the art, various embodiments described herein may be used in additional applications, such as in energy-storage systems for wind and solar power generation. Other embodiments will be apparent to those skilled in the art from consideration of the specification and practice of the disclosed current carrier and battery module. It is intended that the specification and examples be considered as exemplary only, with a true scope being indicated by the following claims and their equivalents.

What is claimed is:

1. A current carrier comprising:
a circuit board configured to be electrically connected to a plurality of battery cells, each battery cell comprising a first end, an anode terminal disposed on the first end of the battery cell, and a cathode terminal disposed on the first end of the battery cell, each of the plurality of battery cells being disposed such that the first end of each of the plurality of battery cells is oriented in the same direction, the circuit board comprising:
a first layer having a first group of positive contacts configured to be electrically connected to cathode terminals of a first group of battery cells among the plurality of battery cells; and
a second layer having a first group of negative contacts configured to be electrically connected to anode terminals of the first group of battery cells.

2. The current carrier of claim 1, wherein the first layer further includes a second group of negative contacts configured to be electrically connected to anode terminals of a second group of battery cells among the plurality of battery cells, and wherein the second layer further includes a second group of positive contacts configured to be electrically connected to cathode terminals of the second group of battery cells.

3. The current carrier of claim 1, wherein the first group of battery cells are electrically connected in parallel.

4. The current carrier of claim 2, wherein the first group of positive contacts and the second group of negative contacts form an electrically connected node.

5. The current carrier of claim 4, wherein the first group of battery cells and the second group of battery cells are electrically connected in series.

6. The current carrier of claim 2, wherein the number of battery cells in the first group is equal to the number of battery cells in the second group.

7. The current carrier of claim 1, wherein the circuit board further comprises:
a base layer having a first side and a second side wherein the first layer is disposed on the first side of the base layer and the second layer is disposed on the second side of the base layer.

8. A battery module comprising:
a plurality of battery cells, each battery cell comprising a first end, an anode terminal disposed on the first end of the battery cell, and a cathode terminal disposed on the first end of the battery cell, each of the plurality of battery cells being disposed such that the first end of each of the plurality of battery cells is oriented in the same direction; and
a current carrier comprising a circuit board, the circuit board comprising a first layer having a first group of positive contacts configured to be electrically connected to cathode terminals of a first group of battery cells among the plurality of battery cells; and a second layer having a first group of negative contacts configured to be electrically connected to anode terminals of the first group of battery cells.

9. The battery module of claim 8, wherein the first layer further includes a second group of negative contacts configured to be electrically connected to anode terminals of a second group of battery cells among the plurality of battery cells, and wherein the second layer further includes a second group of positive contacts configured to be electrically connected to cathode terminals of the second group of battery cells.

10. The battery module of claim 8, wherein the first group of battery cells are electrically connected in parallel.

11. The battery module of claim 9, wherein the first group of positive contacts and the second group of negative contacts form an electrically connected node.

12. The battery module of claim 11, wherein the number of battery cells in the first group is equal to the number of battery cells in the second group.

13. The battery module of claim 9, wherein the circuit board further comprises:
a base layer having a first side and a second side wherein the first layer is disposed on the first side of the base layer and the second layer is disposed on the second side of the base layer.

14. A vehicle comprising:
a battery module, the battery module comprising:
a plurality of battery cells, each battery cell comprising a first end, an anode terminal disposed on the first end of the battery cell, and a cathode terminal disposed on the first end of the battery cell, each of the plurality of battery cells being disposed such that the first end of each of the plurality of battery cells is oriented in the same direction; and
a current carrier comprising a circuit board, the circuit board comprising a first layer having a first group of positive contacts configured to be electrically connected to cathode terminals of a first group of battery cells among the plurality of battery cells; and a second layer having a first group of negative contacts configured to be electrically connected to anode terminals of the first group of battery cells.

15. The vehicle of claim 14, wherein the first layer further includes a second group of negative contacts configured to be electrically connected to anode terminals of a second group of battery cells among the plurality of battery cells, and wherein the second layer further includes a second group of positive contacts configured to be electrically connected to cathode terminals of the second group of battery cells.

16. The vehicle of claim 14, wherein the first group of battery cells are electrically connected in parallel.

17. The vehicle of claim 15, wherein the first group of positive contacts and the second group of negative contacts form an electrically connected node.

18. The vehicle of claim 17, wherein the first group of battery cells and the second group of battery cells are electrically connected in series.

19. The vehicle of claim 15, wherein the number of battery cells in the first group is equal to the number of battery cells in the second group.

20. The vehicle of claim 14, wherein the circuit board further comprises:
a base layer having a first side and a second side wherein the first layer is disposed on the first side of the base layer and the second layer is disposed on the second side of the base layer.
